(19) United States
(12) Patent Application Publication
(10) Pub. No.: US 2002/0185416 A1
(43) Pub. Date: Dec. 12, 2002

(54) Screen cylinder

(76) Inventor: Chao-Ho Chen, Taichung Hsien (TW)

Correspondence Address: Merchant & Gould P.C., P.O. Box 2903, Minneapolis, MN, 55402-0903, US

(21) Appl. No.: 09/935,020

(22) Filed: Aug. 22, 2001

(30) Foreign Application Priority Data
Jun. 7, 2001 (TW) 090209490

(51) Int. Cl. B07B 1/49

(52) U.S. Cl. 209/411; 209/406; 209/395

(57) ABSTRACT

A screen cylinder includes a hollow cylinder body that defines an axis. The cylinder body has a plurality of supporting bars that are parallel to the axis, that are spaced apart at a radial distance from the axis, and that are angularly spaced apart from each other. Each of the supporting bars has a radial inner portion proximate to the axis, and a radial outer portion opposite to the radial inner portion. Each of the supporting bars is formed with a plurality of strip retaining notches at one of the radial inner and radial outer portions. The strip retaining notches of the supporting bars are aligned along a helical path that surrounds the axis. The cylinder body further includes a helical screen strip mounted in the strip retaining notches of the supporting bars and extending along the helical path.

### BACKGROUND OF THE INVENTION

1. Field of the Invention

The invention relates to a screen cylinder, more particularly to a screen cylinder suitable for use in the manufacture of paper.

2. Description of the Related Art

Referring to FIGS. 1 and 2, a conventional screen cylinder disclosed in U.S. Pat. No. 5,394,600 is shown to comprise a plurality of supporting bars 2 and a plurality of supporting plates 1. Each of the supporting plates 1 has an inner surface 101 formed with a plurality of parallel transverse grooves 102 that are arranged at fixed intervals. Each of the supporting bars 2 has a base part 201 formed with a constricted portion 202. During assembly, the supporting plates 1 are placed in a parallel manner in order to align the grooves 102 on one of the supporting plates 1 with the grooves 102 on an adjacent one of the supporting plates 1. Then, in order to mount the supporting bars 2 on the supporting plates 1, the supporting plates 1 are heated to expand the grooves 102, and the constricted portions 201 of the supporting bars 2 are subsequently engaged within the grooves 102. Upon cooling of the supporting plates 1, the grooves 102 will contract to hold the supporting bars 2 tightly. Thereafter, the assembly of the supporting plates 1 and the supporting bars 2 undergoes a rolling process to form a cylindrical screen. Finally, the opposite lateral ends 103 (see FIG. 2) of the supporting plates 1 are welded together to retain the cylindrical shape of the screen. By varying the interval length between the grooves 102 of the supporting plates 1, the distance between the supporting bars 2 can be varied. As such, screen cylinders with various sizes of screening slots can be manufactured for use in the production of recycled paper.

Some of the drawbacks of the aforesaid conventional screen cylinder are as follows: During assembly, insertion of the constricted portions 202 of the supporting bars 2 into the grooves 102 of the supporting plates 1 is inconvenient to conduct and is time-consuming, thereby resulting in a relatively low production yield. Moreover, after rolling the assembly of the supporting plates 1 and the supporting bars 2 to form the cylindrical screen, the opposite lateral ends 103 of the supporting plates 1 must be welded to retain the cylindrical shape of the screen, dictating the need for higher manufacturing precision and thus increasing the production costs.

### SUMMARY OF THE INVENTION

Therefore, the object of the present invention is to provide a screen cylinder that is quick and convenient to manufacture to result in lower production costs.

Accordingly, a screen cylinder of this invention includes a hollow cylinder body that defines an axis. The cylinder body has a plurality of supporting bars that are parallel to the axis, that are spaced apart at a radial distance from the axis, and that are angularly spaced apart from each other. Each of the supporting bars has a radial inner portion proximate to the axis, and a radial outer portion opposite to the radial inner portion. Each of the supporting bars is formed with a plurality of strip retaining notches at one of the radial inner and radial outer portions. The strip retaining notches of the supporting bars are aligned along a helical path that surrounds the axis. The cylinder body further includes a helical screen strip mounted in the strip retaining notches of the supporting bars and extending along the helical path.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view illustrating supporting plates and a supporting bar of a conventional screen cylinder according to U.S. Pat. No. 5,394,600;

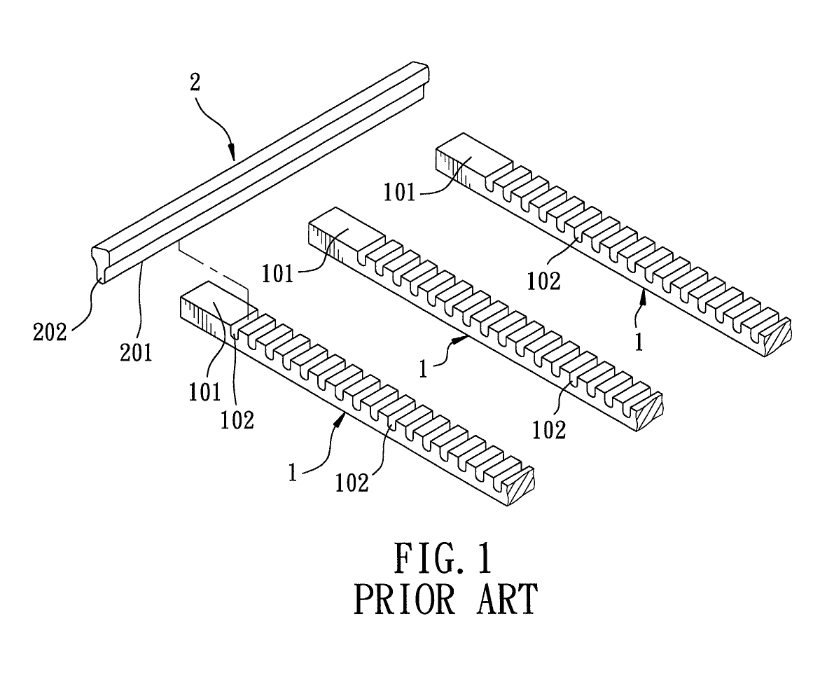

FIG. 2 is a perspective view of the conventional screen cylinder according to U.S. Pat. No. 5,394,600;

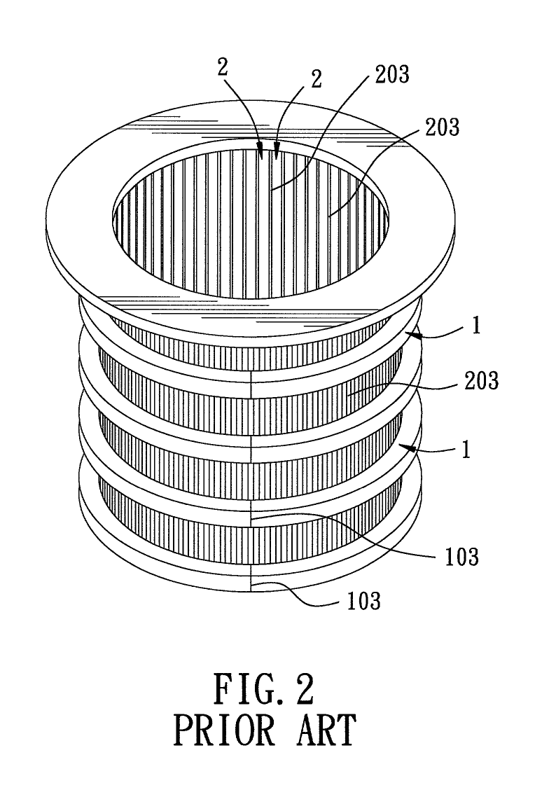

FIG. 3 is a perspective view illustrating the first preferred embodiment of a screen cylinder according to this invention;

FIG. 4 is a fragmentary schematic view of the first preferred embodiment when laid on a flat plane;

FIG. 5 is a perspective view showing how the supporting bars are formed with strip retaining notches with the use of a chuck and a cutter;

FIG. 6 is a sectional view taken along line 6-6 in FIG. 5; and

FIG. 7 is a sectional view similar to FIG. 6 to illustrate the production of the second preferred embodiment of a screen cylinder according to this invention.

### DETAILED DESCRIPTION OF THE PREFERRED EMBODIMENTS

Before the present invention is described in greater detail, it should be noted that like elements are denoted by the same reference numerals in the following description of the preferred embodiments.

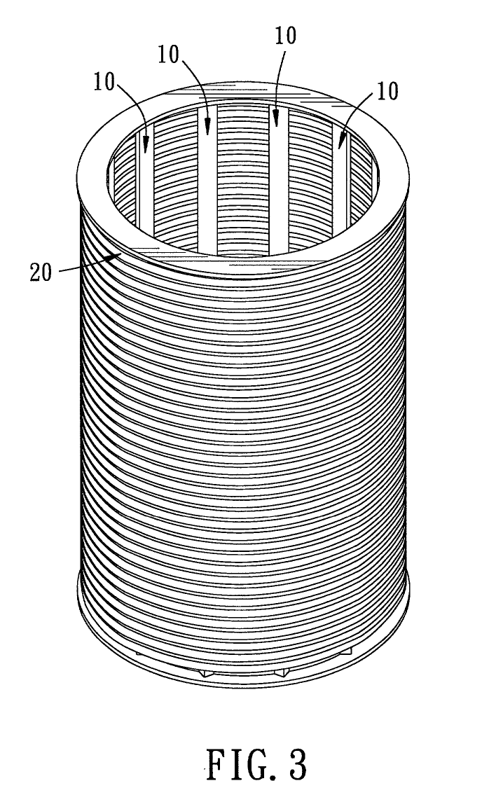

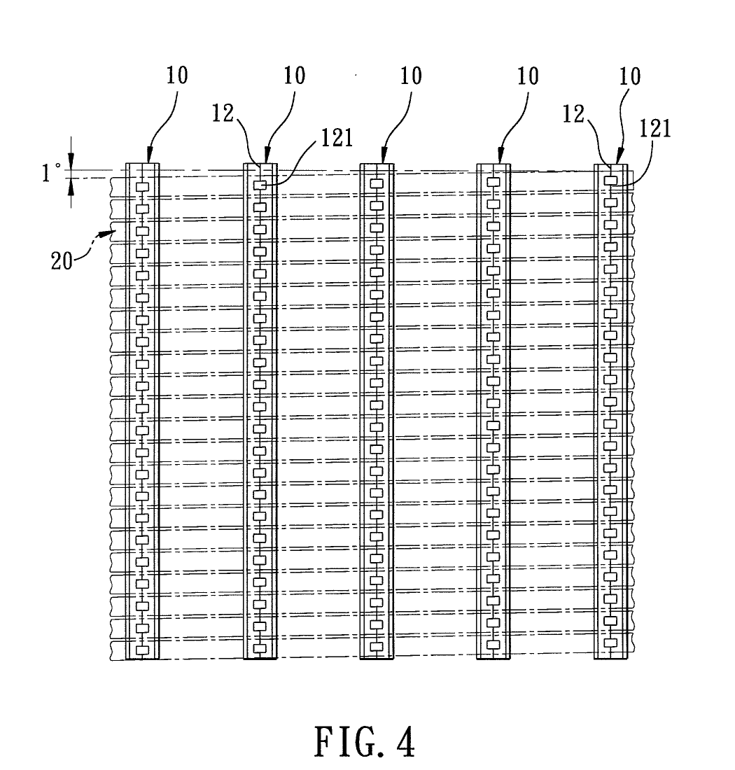

Referring to FIGS. 3 to 6, the first preferred embodiment of a screen cylinder according to this invention is shown to comprise a plurality of supporting bars 10 and a screen strip 20 secured on the supporting bars 10.

Each supporting bar 10, which is made of metal, has a wider radial inner portion 11 and a narrower radial outer portion 12. The supporting bar 10 tapers from the radial inner portion 11 to the radial outer portion 12, and is configured with a generally trapezoidal cross-section. A cutter 30 is applied to cut strip retaining notches 121 on the radial outer portions 12 of the supporting bars 10 along a helical path that surrounds the axis of the screen cylinder.

The screen strip 20, which is made of metal, is pressed by a push member 40 against the supporting bars 10 such that a root portion 21 of the screen strip 20 engages the strip retaining notches 121, thereby allowing the screen strip 20 to extend along the helical path that is formed by the strip retaining notches 121, that surrounds the axis of the screen cylinder, and that has uniform pitch. As such, the screen slots of the screen cylinder are defined by adjacent segments of the screen strip 20 that extend along the helical path.

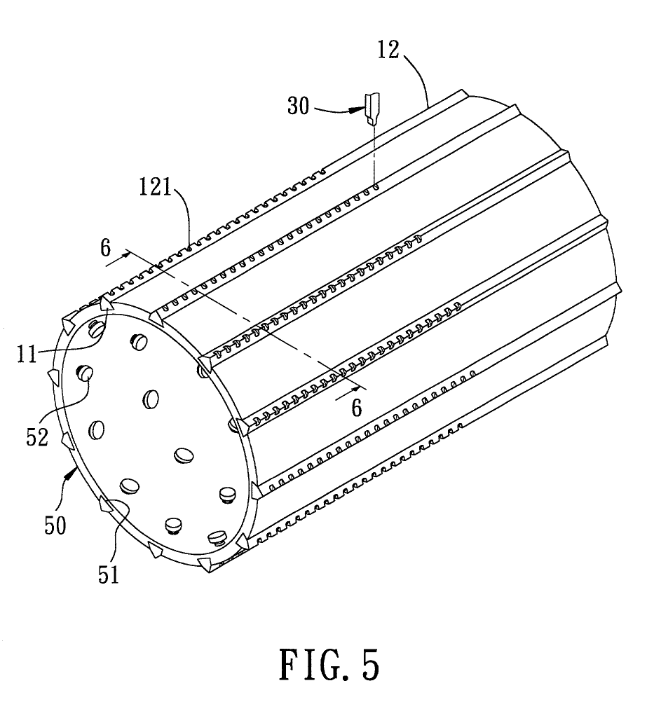

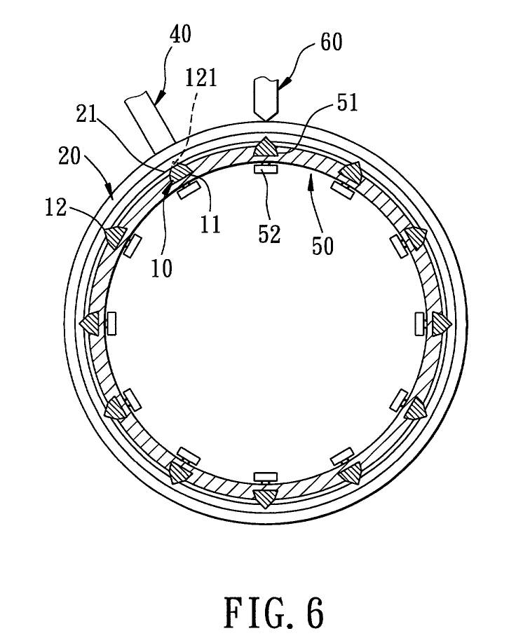

During the manufacture of the screen cylinder of the first preferred embodiment, the supporting bars 10 are initially positioned in positioning grooves 51 on a drum chuck 50 by fasteners 52, as best shown in FIG. 5. After securing the supporting bars 10, they are rotated continuously in a clockwise direction while the cutter 30 moves along the axis of the screen cylinder at a steady pace. In this manner, the continuous cutting operation of the cutter 30 will form the supporting bars 10 with the strip retaining notches 121 that are disposed at equal intervals and that are arranged along a helical path on the radial outer portions 12 of the supporting bars 10. As shown in FIG. 6, the push member 40, which is positioned closely behind the cutter 30, will immediately push the screen strip 20 against the supporting bars 10 such that the root portion 21 thereof engages the strip retaining notches 121. A current-discharging head 60, which is positioned closely behind the push member 40, will discharge an electric current to the screen strip 20 to weld the root portion 21 of the screen strip 20 to the supporting bars 10 at the strip retaining notches 121. The screen cylinder is completed after securing the screen strip 20 to the supporting bars 10.

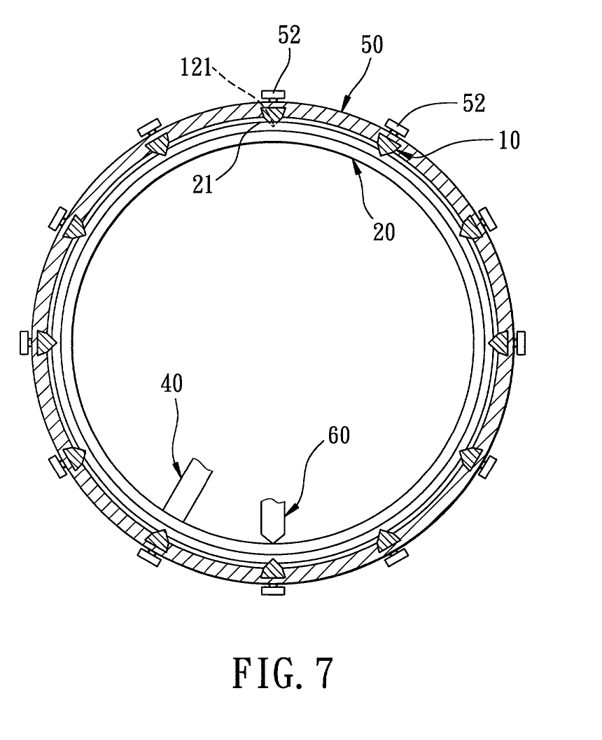

Referring to FIG. 7, the second preferred embodiment of a screen cylinder according to this invention is shown. Unlike the previous embodiment, when the supporting bars 10 are positioned on the drum chuck 50, the strip retaining notches 121 are formed by the cutter (not shown) on the radial inner portions of the supporting bars 10 and face toward the axis of the screen cylinder. Therefore, the screen strip 20 is secured to the radial inner portions of the supporting bars 10. The detailed structure of the supporting bars 10 and the screen strip 20, the operations of the push member 40 and the current-discharging head 60, and the expected effect are similar to those of the first preferred embodiment and will not be described further for the sake of brevity.

It has thus been shown that the screen cylinder of this invention can be manufactured in a quick and convenient manner since it dispenses with the need to engage a plurality of supporting bars into grooves of a plurality of supporting plates and to weld opposite lateral ends of the supporting plates as taught in the aforesaid prior art. The production yield can be increased, and the production costs can be lowered.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A screen cylinder comprising:
a hollow cylinder body that defines an axis, said cylinder body including a plurality of supporting bars that are parallel to said axis, that are spaced apart at a radial distance from said axis, and that are angularly spaced apart from each other, each of said supporting bars having a radial inner portion proximate to said axis and a radial outer portion opposite to said radial inner portion, each of said supporting bars being formed with a plurality of strip retaining notches at one of said radial inner and radial outer portions, said strip retaining notches of said supporting bars being aligned along a helical path that surrounds said axis, said cylinder body further including a helical screen strip mounted in said strip retaining notches of said supporting bars and extending along the helical path.

2. The screen cylinder as claimed in claim 1, wherein said screen strip is welded to said supporting bars at said strip retaining notches.

3. The screen cylinder as claimed in claim 1, wherein each of said supporting bars tapers from the other of said radial inner and outer portions to said one of said radial inner and outer portions.
